(19) United States
(12) Patent Application Publication
(10) Pub. No.: US 2022/0010407 A1
(43) Pub. Date: Jan. 13, 2022

(54) BATTERY RECYCLING BY HYDROGEN GAS INJECTION IN LEACH

(71) Applicant: BASF SE, Ludwigshafen (DE)

(72) Inventors: Wolfgang ROHDE, Ludwigshafen (DE); Torben ADERMANN, Ludwigshafen (DE); Birgit GERKE, Ludwigshafen (DE)

(21) Appl. No.: 17/309,280

(22) PCT Filed: Nov. 18, 2019
(86) PCT No.: PCT/EP2019/081608

§ 371 Date: May 14, 2021

(30) Foreign Application Priority Data
Nov. 26, 2018 (EP) 18208229.7

(51) Int. Cl. C22B 3/00; C22B 7/00; H01M 10/54

(52) U.S. Cl. CPC C22B 23/0415; C22B 7/007; H01M 10/54; C22B 23/0476; C22B 23/0469

(57) ABSTRACT

The present disclosure relates to a process for the recovery of transition metals from batteries comprising treating a transition metal material with a leaching agent to yield a leach which contains dissolved salts of nickel and/or cobalt, injecting hydrogen gas in the leach at a temperature above 100° C. and a partial pressure above 5 bar to obtain a nickel and/or cobalt precipitate in elemental form, and separating the obtained nickel and/or cobalt precipitate.

The present invention relates to a process for the recovery of transition metals from batteries comprising (a) treating a transition metal material with a leaching agent to yield a leach which contains dissolved salts of nickel and/or cobalt, (b) injecting hydrogen gas in the leach at a temperature above 100° C. and a partial pressure above 5 bar to precipitate nickel and/or cobalt in elemental form, and (c) separation of the precipitate obtained in step (b). Combinations of preferred embodiments with other preferred embodiments are within the scope of the present invention.

Lifetime of batteries, especially lithium ion batteries, is not unlimited. It is to be expected, therefore, that a growing number of spent batteries will emerge. Since they contain important transition metals such as, but not limited to cobalt and nickel, and, in addition, lithium, spent batteries may form a valuable source of raw materials for a new generation of batteries. For that reason, increased research work has been performed with the goal of recycling transition metals—and, optionally, even lithium—from used lithium ion batteries.

Various processes have been found to raw material recovery. One process is based upon smelting of the corresponding battery scrap followed by hydrometallurgical processing of the metallic alloy (matte) obtained from the smelting process. Another process is the direct hydro-metallurgical processing of battery scrap materials. Such hydrometallurgical processes will furnish transition metals as aqueous solutions or in precipitated form, for example as hydroxides, separately (DE-A-19842658), or already in the desired stoichiometries for making a new cathode active material, as proposed by Demidov et al., Ru. J. of Applied chemistry 78, 356 (2005).

Hydrometallurgical processes for precipitating transition metals like nickel and cobalt from solutions by reduction generally are known; A. R. Burkin, Powder Metallurgy 12, 243 (1969), describes a kinetic preference towards nickel precipitation. Such processes also include addition of certain nucleating agents (GB-A-740797).

Various objects are pursued by the process of the present invention: An easy, cheap, fast and/or efficient recovery of the transition metals, such as nickel and/or cobalt. Avoid that new impurities are introduced into the process that would require an additional purification step. A high selectivity for removing copper impurities.

The object is achieved by a process for the recovery of transition metals from batteries comprising

(a) treating a transition metal material with a leaching agent to yield a leach which contains dissolved salts of nickel and/or cobalt,
(b) injecting hydrogen gas in the leach at a temperature above 100° C. and a partial pressure above 5 bar to precipitate nickel and/or cobalt in elemental form, and
(c) separation of the precipitate obtained in step (b).

Recovery of transition metals from batteries, such as lithium ion batteries, usually means that the transition metals (e.g. nickel, cobalt and/or manganese) and optionally further valuable elements (e.g. lithium and/or carbon) can be at least partly recovered, typically at a recovery rate of each at least 10, 20, 30, 40, 50, 60, 70, 80, 90, or 95 wt %. Preferably, at least nickel, cobalt and/or lithium is recovered by the process.

The transition metals and optionally further valuable elements are recovered from batteries, preferably lithium ion batteries, such as used or new batteries, parts of batteries, off-spec materials thereof (e.g. that do not meet the specifications and requirements), or production waste from battery production.

The transition metal material is usually a material that stems from the batteries, preferably the lithium ion batteries. For safety reasons, such batteries are discharged completely, otherwise, shortcuts may occur that constitute fire and explosion hazards. Such lithium ion batteries may be disassembled, punched, milled, for example in a hammer mill, or shredded, for example in an industrial shredder. From this kind of mechanical processing the active material of the battery electrodes may be obtained containing a transition metal material which may have a regular shape, but usually it has irregular shape. It is preferred, though, to remove a light fraction such as housing parts made from organic plastics and aluminum foil or copper foil as far as possible, for example in a forced stream of gas, air separation or classification. The transition metal material may also be obtained as metal alloy from smelting battery scrap. Preferably, the transition metal material is obtained from lithium ion batteries and contains lithium.

The transition metal material is often from battery scraps of batteries, such as lithium ion batteries. Such battery scraps may stem from used batteries or from production waste, for example off-spec material. In a preferred form the transition metal material is obtained from mechanically treated battery scraps, for example from battery scraps treated in a hammer mill or in an industrial shredder. Such transition metal material may have an average particle diameter (D50) in the range of from 1 μm to 1 cm, preferably from 1 to 500 μm, and in particular from 3 to 250 μm. Bigger parts of the battery scrap like the housings, the wiring and the electrode carrier films are usually separated mechanically such that the corresponding materials can be widely excluded from the transition metal material that is employed in the process. The mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1 to 99% by weight of water.

The mechanically treated battery scrap may be subjected to a heat treatment in a wide range of temperatures under different atmospheres. The temperature range is usually in the range of 100 to 900° C. Lower temperatures below 300° C. serve to evaporate residual solvents from the battery electrolyte, at higher temperatures the binder polymers may decompose while at temperatures above 400° C. the composition of the inorganic materials may change as some transition metal oxides may become reduced either by the carbon contained in the scrap material or by introducing reductive gases. By such a heat treatment the morphology of the transition metal material is usually retained, only the chemical composition may be altered. However, such heat treatment is fundamentally different from a smelting process where molten transition metal alloys and molten slags are formed. After such a heat treatment the material obtained may be leached with water or weak or diluted acids in order to dissolve selectively easy soluble constituents especially salts of lithium that may have been formed during the heat treatment e.g. lithium carbonate and lithium hydroxide. In one form the transition metal material is obtained from mechanical processing of battery scrap that has been heat treated (e.g. at 100 to 900° C.) and optionally under a hydrogen atmosphere or an atmosphere containing carbon monoxide.

Preferably, the transition metal material is obtained from mechanically treated battery scraps, or it is obtained as metal alloy from smelting battery scrap.

The transition metal material may contain lithium and its compounds, carbon in electrically conductive form (for example graphite, soot, and graphene), solvents used in electrolytes (for example organic carbonates such as diethyl carbonate), aluminum and compounds of aluminum (for example alumina), iron and iron compounds, zinc and zinc compounds, silicon and silicon compounds (for example silica and oxidized silicon SiO_{y} with zero<y<2), tin, silicon-tin alloys, and organic polymers (such as polyethylene, polypropylene, and fluorinated polymers, for example polyvinylidene fluoride), fluoride, compounds of phosphorous (that may stem from liquid electrolytes, for example in the widely employed LiPF₆ and products stemming from the hydrolysis of LiPF₆).

The transition metal material may contain 1-30 wt %, preferably 3-25 wt %, and in particular 8-16 wt % nickel, as metal or in form of one or more of its compounds.

The transition metal material may contain 1-30 wt %, preferably 3-25 wt %, and in particular 8-16 wt % cobalt, as metal or in form of one or more of its compounds.

The transition metal material may contain 1-30 wt %, preferably 3-25 wt %, and in particular 8-16 wt % manganese, as metal or in form of one or more of its compounds

The transition metal material may contain 0.5-45 wt %, preferably 1-30 wt %, and in particular 2-12 wt % lithium, as metal or in form of one or more of its compounds

The transition metal material may contain 100 ppm to 15% by weight of aluminum, as metal or in form of one or more of its compounds.

The transition metal material may contain 20 ppm to 3% by weight of copper, as metal or in form of one or more of its compounds.

The transition metal material may contain 100 ppm to 5% by weight of iron, as metal or alloy or in form of one or more of its compounds. The transition metal material may contain 20 ppm to 2% by weight of zinc, as metal or alloy or in form of one or more of its compounds. The transition metal material may contain 20 ppm to 2% by weight of zirconium, as metal or alloy or in form of one or more of its compounds. The transition metal material may contain 20 ppm to 2% by weight of tungsten, as metal or alloy or in form of one or more of its compounds. The transition metal oxide material may contain 0.5% to 10% by weight of fluorine, calculated as a sum of organic fluoride bound in polymers and inorganic fluoride in one or more of its inorganic fluorides. The transition metal material may contain 0.2% to 10% by weight of phosphorus. Phosphorus may occur in one or more inorganic compounds.

The transition metal material usually contains nickel and at least one of cobalt and manganese. Examples of such transition metal materials may be based on LiNiO₂, on lithiated nickel cobalt manganese oxide (“NCM”) or on lithiated nickel cobalt aluminum oxide (“NCA”) or mixtures thereof.

Examples of layered nickel-cobalt-manganese oxides are compounds of the general formula Li₁₊ₓ(NiₐCo_{b}Mn_{c}M¹d)₁₋ₓO₂ with M¹ being selected from Mg, Ca, Ba, Al, Ti, Zr, Zn, Mo, V and Fe, the further variables being defined as follows: zero≤x≤0.2, 0.1≤a≤0.95, Zero≤b≤0.9, preferably 0.05<b≤0.5, zero≤c≤0.6, zero≤d≤0.1, and a+b+c+d=1. Preferred layered nickel-cobalt-manganese oxides are those where M¹ is selected from Ca, Mg, Zr, Al and Ba, and the further variables are defined as above. Preferred layered nickel-cobalt-manganese oxides are Li₍₁₊ₓ₎[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.1}]₍₁₋ₓ₎O₂, and Li₍₁₊ₓ₎[Ni_{0.8}Co_{0.1}Mn_{0.1}]₍₁₋ₓ₎O₂, each with x as defined above.

Examples of lithiated nickel-cobalt aluminum oxides are compounds of the general formula Li[NiₕCoᵢAlⱼ]O₂₊ᵣ, where h is in the range of from 0.8 to 0.95, i is in the range of from 0.2 to 0.3, j is in the range of from 0.01 to 0.1, and r is in the range of from zero to 0.4. A preferred layered nickel-cobalt-aluminum oxide is Li[Ni_{0.85}Co_{0.13}Al_{0.02}]O₂.

Prior Step (a)

Optionally, the transition metal material can be treated prior step (a) by various methods.

It is possible to at least partially remove used electrolytes before step (a), especially used electrolytes that comprise an organic solvent or a mixture of organic solvents, for example by mechanic removal or drying, for example at temperatures in the range of from 50 to 300° C. A preferred range of pressure for the removal of organic solvent(s) is 0.01 to 2 bar, preferably 10 to 100 mbar.

Before step (a) it is preferred to wash the transition metal material with water and to thereby remove liquid impurities and water-soluble impurities from the transition metal material. Said washing step may be improved by a grinding for example in a ball mill or stirred ball mill. The washed transition metal material may be recovered by a solid-liquid separation step, for example a filtration or centrifugation or any kind of sedimentation and decantation. In order to support the recovery of finer particles of such solid transition metal material, flocculants may be added, for example polyacrylates.

It is also possible to wash the transition metal material with an organic solvent to remove soluble organic and inorganic components e.g. electrolyte solvents and the conducting salts. Such a washing may be preferably combined with the aforementioned washing for the removal of binder polymers.

In the case of a heat treated transition metal material the washing is preferably done with water or an aqueous medium capable to dissolve lithium salts that may have been formed during the heat treatment. Typically, pure water or water carbon dioxide mixtures—the latter being applied preferably under pressure—or solution of weak acids e.g. acetic or formic acid can be employed. These acids are selected such as to avoid the dissolution of any transition metal and allow a facile recovery of lithium carbonate or lithium hydroxide. So, lithium carbonate may be recovered from lithium bicarbonate or lithium formiate.

Before step (a) at least one solid-solid separation step can be made, for example for the at least partial removal of carbon and/or polymeric materials. Examples of solid-solid separation steps are classification, gravity concentration, flotation, dense media separation, magnetic separation and electrosorting. Usually an aqueous slurry obtained prior to step (a) may be subjected to the solid-solid separation except for the electrosorting which is done under dry conditions. The solid-solid separation step often serves to separate hydrophobic non-soluble components like carbon and polymers from the metal or metal oxide components.

The solid-solid separation step may be performed by mechanical, column or pneumatic or hybrid flotations. Collector compounds may be added to the slurry which render the hydrophobic components even more hydrophobic. Suitable collector compounds for carbon and polymeric materials are hydrocarbons or fatty alcohols which are introduced in amounts of 1 g/t to 50 kg/t of transition metal material.

It is also possible to perform the flotation in an inverse sense, i.e., transforming the originally hydrophilic components into strongly hydrophobic components by special collector substances, e.g., fatty alcohol sulfates or esterquats. Preferred is the direct flotation employing hydrocarbon collectors. In order to improve the selectivity of the flotation towards carbon and polymeric material particles suppressing agents can be added that reduce the amounts of entrained metallic and metal oxide components in the froth phase. Suppressing agents that can be used may be acids or bases for controlling the pH value in a range of from 3 to 9 or ionic components that may adsorb on more hydrophilic components. In order to increase the efficiency of the flotation it may be advantageous to add carrier particles that form agglomerates with the hydrophobic target particles under the flotation conditions.

Magnetic or magnetizable metal or metal oxide components may be separated by magnetic separation employing low, medium or high intensity magnetic separators depending on the susceptibility of the magnetizable components. It is possible as well to add magnetic carrier particles. Such magnetic carrier particles are able to form agglomerates with the target particles. By this also non-magnetic materials can be removed by magnetic separation techniques. preferably, magnetic carrier particles can be recycled within the separation process.

By the solid-solid separation steps typically at least two fractions of solid materials present as slurries will be obtained: One containing mainly the transition metal material and one containing mainly the carbonaceous and polymeric battery components. The first fraction may be then fed into step (a) of the present invention while the second fraction may be further treated in order to recover the different constituents i.e. the carbonaceous and polymeric material.

Step (a)

Step (a) includes treating the transition metal material with the leaching agent to yield a leach which contains the dissolved salts of nickel and/or cobalt. In one form the leach contains the dissolved salts of cobalt. In a preferred form the leach contains the dissolved salts of nickel. In another preferred form the leach contains the dissolved salts of nickel and cobalt.

In the course of step (a), the transition metal material is treated with a leaching agent, which is preferably an acid selected from sulfuric acid, hydrochloric acid, nitric acid, methanesulfonic acid, oxalic acid and citric acid or a combination of at least two of the foregoing, for example a combination of nitric acid and hydrochloric acid. In another preferred form the leaching agent is an

inorganic acid such as sulfuric acid, hydrochloric acid, nitric acid,
an organic acid such as methanesulfonic acid, oxalic acid, citric acid, aspartic acid, malic acid, ascorbic acid, or glycine,
a base, such as ammonia, aqueous solutions of amines, ammonia, ammonium carbonate or a mixture of ammonia and carbon dioxide, or
a chelating agent, such as EDTA or dimethylglyoxime.

In one form, the leaching agent comprises an aqueous acid, such as an inorganic or organic aqueous acid. In another form the leaching agent comprises a base, preferable ammonia or an amine. In another form the leaching agent comprises a complex former, preferably a chelating agent. In another form the leaching agent comprises an inorganic acid, an organic acid, a base or a chelating agent.

The concentration of leaching agents may be varied in a wide range, for example of 0.1 to 98% by weight and preferably in a range between 10 and 80%. Preferred example of aqueous acids is aqueous sulfuric acid, for example with a concentration in the range of from 10 to 98% by weight. Preferably, aqueous acid has a pH value in the range of from −1 to 2. The amount of acid is adjusted to maintain an excess of acid referring to the transition metal. Preferably, at the end of step (a) the pH value of the resulting solution is in the range of from −0.5 to 2.5. Preferred examples of a base as leaching agents are aqueous ammonia with a molar NH₃ to metal (Ni, Co) ratio of 1:1 to 6:1, preferably 2:1 to 4:1, preferably also in the presence of carbonate or sulfate ions. Suitable chelating agents like EDTA or dimethylglyoxime are often applied in a molar ratio of 1:1 to 3:1.

The leaching may be carried out in the presence of oxidizing agents. A preferred oxidizing agent is oxygen as pure gas or in mixtures with inert gases e.g. nitrogen or as air. Other oxidizing agents are oxidizing acids e.g. nitric acid or peroxides for example hydrogen peroxide.

The treatment in accordance with step (a) may be performed at a temperature in the range of from 20 to 130° C. If temperatures above 100° C. are desired, step (a) is carried out at a pressure above 1 bar. Otherwise, normal pressure is preferred. In the context of the present invention, normal pressure means 1 bar.

In one form step (a) is carried out in a vessel that is protected against strong acids, for example molybdenum and copper rich steel alloys, nickel-based alloys, duplex stainless steel or glass-lined or enamel or titanium coated steel. Further examples are polymer liners and polymer vessels from acid-resistant polymers, for example polyethylene such as HDPE and UHMPE, fluorinated polyethylene, perfluoroalkoxy alkanes (“PFA”), polytetrafluoroethylene (“PTFE”), PVdF and FEP. FEP stands for fluorinated ethylene propylene polymer, a copolymer from tetrafluoroethylene and hexafluoropropylene.

The slurry obtained from step (a) may be stirred, agitated, or subjected to a grinding treatment, for example in a ball mill or stirred ball mill. Such grinding treatment leads often to a better access of water or acid to a particulate transition metal material.

Step (a) has often a duration in the range of from 10 minutes to 10 hours, preferably 1 to 3 hours. For example, the reaction mixture in step (a) is stirred at powers of at least 0.1 W/l or cycled by pumping in order to achieve a good mixing and to avoid settling of insoluble components. Shearing can be further improved by employing baffles. All these shearing devices need to be applied sufficiently corrosion resistant and may be produced from similar materials and coatings as described for the vessel itself.

Step (a) may be performed under an atmosphere of air or under air diluted with N₂. It is preferred, though, to perform step (a) under inert atmosphere, for example nitrogen or a rare gas such as Ar.

The treatment in accordance with step (a) leads in the leach usually to a dissolution of the transition metal containing material, for example of said NCM or NCA including impurities other than carbon and organic polymers. The leach may be obtained as a slurry after carrying out step (a). Lithium and transition metals such as, but not limited to nickel, cobalt, copper and, if applicable, manganese, are often in dissolved form in the leach, e.g. in the form of their salts.

Step (a) may be performed in the presence of a reducing agent. Examples of reducing agents are organic reducing agents such as methanol, ethanol, sugars, ascorbic acid, urea, bio-based materials containing starch or cellulose, and inorganic reducing agents such as hydrazine and its salts such as the sulfate, and hydrogen peroxide. Preferred reducing agents for step (a) are those that do not leave impurities based upon metals other than nickel, cobalt, or manganese. Preferred examples of reducing agents in step (a) are methanol and hydrogen peroxide. With the help of reducing agents, it is possible to, for example, reduce Co³⁺ to Co²⁺ or Mn(+IV) or Mn³⁺ to Mn²⁺. Preferably an excess of reducing agent is employed, referring to the amount of Co and—if present—Mn. Such excess is advantageous in case that Mn is present.

In embodiments wherein a so-called oxidizing acid has been used in step (a) it is preferred to add reducing agent in order to remove non-used oxidant. Examples of oxidizing acids are nitric acid and combinations of nitric acid with hydrochloric acid. In the context of the present invention, hydrochloric acid, sulfuric acid and methanesulfonic acid are preferred examples of non-oxidizing acids.

Depending on the concentration of the acid used, the leach obtained in step (a) may have a transition metal concentration in the range of from 1 up to 20% by weight, preferably 3 to 15% by weight.

Between Steps (a) and (b)

The leach from step (a) can be treated by various methods before using it in step (b), such as by the steps (a1), (a2), and/or (a3). In a preferred form the steps (a1), (a2), and (a3) are carried out in the given order.

An optional step (a1) that may be carried out after step (a) and before step (b) is a removal of non-dissolved solids from the leach. The non-dissolved solids are usually carbonaceous materials, preferably carbon particles, and in particular graphite particles. The non-dissolved solids, such as the carbon particles, can be present in form of particles which have a particle size D50 in the range from 1 to 1000 μm, preferably from 5 to 500 μm, and in particular from 5 to 200 μm. The D50 may be determined by laser diffraction. The step (a1) may be carried out by filtration, centrifugation, settling, or decanting. In step (a1) flocculants may be added. The removed non-dissolved solids can be washed, e.g. with water, and optionally be further treated in order to separate the carbonaceous and polymeric components. Usually, any step preceding step (a), and step (a1) are performed sequentially in a continuous operation mode.

A preferred form of step (a1) is removing of non-dissolved solids from the leach, where the non-dissolved solids are carbon particles (preferably graphite particles).

Another optional step (a2) that may be carried out after step (a) or after step (a1) and before step (b) is adjusting the pH value of the leach to 2.5 to 8, preferably to 5.5 to 7.5 and in particular to 6 to 7. The pH value may be determined by conventional means, for example potentiometrically, and refers to the pH value of the continuous liquid phase at 20° C. The adjustment of the pH value is usually done by dilution with water, by addition of bases, by addition of acids, or by a combination thereof. Examples of suitable bases are ammonia and alkali metal hydroxides, for example LiOH, NaOH or KOH, in solid form, for example as pellets, or preferably as aqueous solutions. Combinations of at least two of the foregoing are feasible as well, for example combinations of ammonia and aqueous caustic soda. Step (a2) is preferably performed by the addition of at least one of sodium hydroxide, lithium hydroxide, ammonia and potassium hydroxide.

Another optional step (a3) that may be carried out after step (a2) and before step (b) is the removing of precipitates of phosphates, oxides, hydroxides or oxyhydroxides (e.g. of metals like Al, Fe, Sn, Si, Zr, Zn, or Cu or combinations thereof) by solid-liquid separation. Said precipitates may form during adjustment of the pH value in step (a2). Phosphates may be stoichiometric or basic phosphates. Without wishing to be bound by any theory, phosphates may be generated on the occasion of phosphate formation through hydrolysis of hexafluorophosphate. It is possible to remove the precipitates by solid-liquid separation such as filtration or with the help of a centrifuge or by sedimentation. Preferred filters are belt filters, filter press, suction filters, and cross-flow filter.

Preferably, the process comprises the steps (a2) adjusting the pH value of the leach to 2.5 to 8, and (a3) removing of precipitates of phosphates, oxides, hydroxides or oxyhydroxides.

Another optional step (a4) that may be carried out before step (b) is the removing of metal ions (e.g. of metals like Ag, Au, platin group metals, or copper, where copper is preferred) by electrowinning.

Another optional step (a5) that may be carried out after step (a) and before step (b) is the removing of precious metals and/or copper from the leach by cementation, e.g. on nickel, cobalt or manganese particles.

Another optional step (a6) that may be carried out after step (a) and before step (b) is the removing of precious metals and/or copper from the leach by depositing the dissolved precious metals and/or copper impurities as elemental precious metal and/or copper on a particulate deposition cathode, e.g. graphite particles, by electrolysis of an electrolyte containing the leach. The electrolysis can be run potentiostatic or galvanostatic, wherin potentiostatic is preferred. The electrolyte is usually an aqueous electrolyte. The electrolyte may have a pH above 1, 2, 3, 4, or 5, preferably above 5. The electrolyte may have a pH below 10, 9, or 8. In another form the electrolyte may have a pH from 4 to 8. The electrolyte may contain buffer salts, e.g. salts of acetate, to adjust the pH value. The deposition cathode may have a particle size d50 in the range from 1 to 1000 μm, preferably from 5 to 500 μm, and in particular from 5 to 200 μm. The electrolyte may have a pH from 4 to 8. In particular the electrolysis is made in an electro-chemical filter flow cell in which the electrolyte is passed through a deposition cathode in form of a particulate filter-aid layer. The electro-chemical filter flow cell comprises usually a flow cell anode, which can be made of anode materials as given above. The flow cell anode and the deposition cathode may be separated by a diaphragm or a cation exchange membrane as mentioned above. The deposited metals be separated, re-dissolved and precipitated as e.g. hydroxides.

Step (b)

The leach usually comprises a concentration of the nickel salts from 0.1 wt.-% to 15 wt.-%, preferably from 0.5 wt.-% to 12 wt.-%, and in particular from 1 to 10 wt.-%, where the amount refers to nickel.

The leach usually comprises a concentration of the cobalt salts from 0.1 wt.-% to 15 wt.-%, preferably from 0.5 wt.-% to 12 wt.-%, and in particular from 1 to 10 wt.-%, where the amount refers to cobalt.

The injection of the hydrogen gas can be made in commercial devices, such as high-pressure autoclaves.

The injection of hydrogen gas is usually made by conventional means, such a pipe which ends inside the reactor within or above the leach.

Hydrogen gas from various commercial sources can be used. Preferred is hydrogen gas containing low amounts of sulfur. Such hydrogen gas can be obtained by electrolysis of water, preferably by electricity obtained from renewable resources e.g. water wind or solar power.

The hydrogen gas may contain various amounts of inert gas, such as nitrogen. Typically, the hydrogen gas contains below 5 vol.-% inert gas.

The hydrogen gas is injected in the leach at the temperature of above 100° C., preferably above 130° C., and in particular above 150° C. In a preferred form the hydrogen gas is injected in the leach at a temperature of 150 to 280° C.

The hydrogen gas is injected in the leach at a partial pressure of above 5 bar, preferably above 10 bar, and in particular above 15 bar. In a preferred form the hydrogen gas is injected in the leach at a partial pressure of 5 to 60 bar. In a further preferred embodiment, the hydrogen gas is injected in the leach at a partial pressure from the range 30 to 100 bar, especially 45 to 100 bar.

The pH of the leach can be adjusted before or during the injection of the hydrogen gas. As the reduction produces acid a continuous neutralization of the acid is preferred to keep the acid concentration low. Generally, the hydrogen gas is injected in the leach at a pH-value above 4, preferably above 6, and in particular above 8. The pH-value can be adjusted by continuously feeding of bases while controlling the pH-value. Suitable bases are ammonia, or alkali hydroxides or carbonates, where ammonia is preferred. In a preferred form the hydrogen reduction is done in the presence of a suitable buffer system. Examples of such a buffer system are ammonia and ammonium salts like ammonium carbonate, ammonium sulfate or ammonium chloride. When using such buffer systems, the ratio of ammonia to nickel or to nickel and cobalt should be in the range of 1:1 to 6:1, preferably 2:1 to 4:1.

A nickel-reduction catalyst and/or a cobalt-reduction catalyst may be present in the leach during the injection of the hydrogen gas, such as metallic nickel, metallic cobalt, ferrous sulfate, ferrous sulfate modified with aluminum sulfate, palladium chloride, chromous sulfate, ammonium carbonate, manganese salts, platinic chloride, ruthenium chloride, potassium/ammonium tetrachloro-platinate, ammonium/sodium/potassium hexachloroplatinat, or silver salts (e.g. nitrate, oxide, hydroxide, nitrites, chloride, bromide, iodide, carbonate, phosphate, azide, borate, sulfonates, or carboxylates or silver). Ferrous sulfate, aluminum sulfate and manganese sulfate may be present in the leach from corresponding components of the transition metal material. Preferred nickel-reduction catalysts and/or a cobalt-reduction catalyst are ferrous sulfate, aluminum sulfate, manganese sulfate and ammonium carbonate.

A preferred nickel-reduction catalyst is metallic nickel, in particular metallic nickel powder. A preferred cobalt-reduction catalyst is metallic cobalt powder. These metal powders of nickel or cobalt may be obtained in-situ at the beginning of the reduction process or ex-situ in a separate reactor by reducing aqueous Ni and Co salt solutions.

An seeding crystal promoter for the formation of metallic seeding crystals may be present in the leach during the injection of the hydrogen gas. Several seeding crystal promoters are known in the art (thiourea, thioacetamide, thioacetanilid, thioacetic acid alkali salts (e.g. U.S. Pat. No. 3,775,098); alkali salts of xanthates; non-gaseous, non-metallic reducing agents like sodium hypophosphite, sodium nitrite, sodium dithionite (e.g. U.S. Pat. No. 2,767,083); formaldehyde sulfoxalate (rongalite) (e.g. U.S. Pat. No. 4,758,266); non-gaseous, non-metallic, non-reducing promotors like sulfur, sulfide, graphite (e.g. U.S. Pat. No. 2,767,081) the latter may be obtained from the battery scrap, catalytic non-gaseous, non-metallic promotors like hydrazine, hydroquinone (e.g. U.S. Pat. No. 2,767,082)). Known in the art are also seeding crystal promoters that control the morphology of the precipitates (ethylene maleic acid anhydride polymer (e.g. U.S. Pat. No. 3,694,185); acrylic polymers, lignin (e.g. CA580508); ammonium or alkali metal salts of maleic acid anhydride copolymer and olefinic hydrocarbon (e.g. U.S. Pat. No. 3,989,509); bone glue or polyacrylic acids or mixtures of the two (e.g. U.S. Pat. No. 5,246,481); addition of solids (e.g. EP 3369469). Employing Ni or Co or other metal seeding crystals, mixed metal particles may be obtained (e.g. U.S. Pat. No. 2,853,403).

The amount of the nickel-reduction catalyst and/or the cobalt-reduction catalyst depends on the selected type of catalyst. In general, at least 0.001 g of the nickel-reduction catalyst and/or the cobalt-reduction catalyst per liter of leach are present.

In a preferred form the leach contains dissolved salts of nickel, and in step (b) nickel in elemental form is precipitated, optionally in the presence of a nickel-reduction catalyst.

In a form the leach contains dissolved salts of cobalt and in step (b) cobalt in elemental form is precipitated, optionally in the presence of a cobalt-reduction catalyst.

In another preferred form the leach contains dissolved salts of nickel and of cobalt, and in step (b) nickel and cobalt in elemental form is precipitated, optionally in the presence of a nickel-reduction catalyst and a cobalt-reduction catalyst.

In another preferred form the leach contains dissolved salts of nickel and of cobalt, and in step (b) nickel in elemental form is precipitated, optionally in the presence of a nickel-reduction catalyst, and where the precipitate may contain 0 to 50 wt % of cobalt in elemental form.

In another form the leach contains dissolved salts of nickel and of cobalt, and in step (b) cobalt in elemental form is precipitated, optionally in the presence of a cobalt-reduction catalyst, and where the precipitate may contain 0 to 50 wt % of nickel in elemental form.

The process may comprise two or more steps of injecting the hydrogen gas in the leach. The steps are usually carried out in the given order.

In a preferred form the process comprises

(a) treating the transition metal material with the leaching agent to yield the leach which contains dissolved salts of nickel and cobalt,
(b1) injecting hydrogen gas in the leach at a temperature above 100° C. and a partial pressure above 5 bar, and optionally in the presence of a nickel-reduction catalyst, to precipitate nickel in elemental form,
(c1) separation of the precipitate obtained in step (b1) to yield a cobalt solution comprising the dissolved salts of cobalt,
(b2) injecting hydrogen gas in the cobalt solution at a temperature above 100° C. and a partial pressure above 5 bar, and optionally in the presence of a cobalt-reduction catalyst, to precipitate cobalt in elemental form, and
(c2) separation of the precipitate obtained in step (b2).

In another form the process comprises

(a) treating the transition metal material with the leaching agent to yield the leach which contains dissolved salts of nickel and cobalt,
(b3) injecting hydrogen gas in the leach at a temperature above 100° C. and a partial pressure above 5 bar, and optionally in the presence of a cobalt-reduction catalyst, to precipitate cobalt in elemental form,
(c3) separation of the precipitate obtained in step (b3) to yield a nickel solution comprising the dissolved salts of nickel,
(b4) injecting hydrogen gas in the nickel solution at a temperature above 100° C. and a partial pressure above 5 bar, and optionally in the presence of a nickel-reduction catalyst, to precipitate nickel in elemental form, and
(c4) separation of the precipitate obtained in step (b4).

In a preferred form the leach contains at least one further dissolved component selected from inorganic salts of iron, manganese, lithium, zinc, tin, zirconium, aluminum, tungsten, and the further dissolved components remain in dissolved form during step (b).

Further Steps

The step (c) comprises a separation of the precipitate obtained in step (b) and optionally in (b1), (b2), (b3), or (b4). This can be achieved by solid-liquid separation, magnetic separation, filtration or sedimentation, preferably by filtration or sedimentation. In case where other solid residues are present in the leach obtained in step (a) that have not been separated it is preferred to separate the elemental nickel and/or the elemental cobalt by magnetic separation.

Optionally, the step (c) and optionally in (c1), (c2), (c3), or (c4) may be followed by further steps, such as (d) and/or step (e).

Having separated the elemental nickel and/or the elemental cobalt in step (c) further treatments of these metals (e.g. by step (d)) and the residual suspension or solution obtained in step (c) (e.g. by step (e)) are possible.

In optional step (d) the separated metals (e.g. elemental nickel and/or cobalt) are further purified. Residual hydroxides of iron, manganese and aluminum may be dissolved and removed by washing the separated metals with weak or diluted acids. To separate residual copper the mixed metals can be re-dissolved in an acid (e.g. those described for step (a)) and copper can be recovered selectively by precipitation as hydroxide or as sulfide under acidic conditions or by electrowinning.

In another form of step (d) the separated metals are further purified by dissolving them and removing of precious metals and/or copper by cementation, e.g. on nickel, cobalt or manganese particles.

In another form of step (d) the separated metals are further purified by dissolving them and removing of precious metals and/or copper by depositing the dissolved precious metals and/or copper impurities as elemental precious metal and/or copper on a particulate deposition cathode, e.g. graphite particles, by electrolysis of an electrolyte containing the leach. The electrolysis is preferably made in an electrochemical filter flow cell.

Finally, a purified solution containing nickel and/or cobalt salts may be obtained. From this solution nickel and cobalt may be separated e.g. by solvent extraction or electrowinning. In a preferred form the mixed nickel cobalt salt solution is directly used for the production of cathode active material of the NCM or NCA type.

The residual suspension or solution obtained in step (c) may contain all metals that are less noble than nickel, cobalt and copper, such as iron, manganese, aluminum and lithium. These metals may be present as solids precipitated at pH-values above 2.5 during step (b) or may be present as dissolved salts. In cases where lithium has not been recovered in any preceding step lithium may be present as dissolved salt. The residual suspension may be further treated in optional step (e) to precipitate residual metal salts as hydroxides or sulfides or both and then subjected to a solid-liquid separation e.g. a filtrationor centrifugation (decanting) or magnetic separation, to obtain a solution containing a pure lithium salt. From this solution lithium may be recovered as lithium carbonate by precipitation with soda ash or by electrolysis or electro-dialysis producing lithium hydroxide and the corresponding acid of the lithium salt.

### EXAMPLES

The metal impurities and phosphorous are determined by elemental analysis using ICP-OES (inductively coupled plasma—optical emission spectroscopy) or ICP-MS (inductively coupled plasma—mass spectrometry). Total carbon is determined with a thermal conductivity detector (CMD) after combustion. Fluorine is detected with an ion sensitive electrode (ISE) after combustion for total fluorine (DIN EN 14582:2016-12) or after H₃PO₄ distillation for ionic fluoride (DIN 38405-D4-2:1985-07). “w %” stands for percent by weight of the sample.

### Example 1

a) 3 g of a material obtained from a thermal treatment of waste battery material at a temperature of 800° C., the material containing cobalt (6.3 w %), nickel (7.4 w %), copper (2 w %), lithium (0.57 w %), graphite (23 w %), aluminum (6.5 w %), iron (0.2 w %), zinc (0.2 w %), fluorine (2.4 w %), phosphorus (0.4 w %) and manganese (6.8 w %) is treated with 146.03 g of a solution of 21 w % ammonium hydroxide and 9 w % of ammonium carbonate in water at 60° C. for 5 h. After cooling, the suspension is filtered and washed with deionized water to give (including the washing water) 197.06 g of a leaching filtrate containing 0.081 w % cobalt, 0,094 w % nickel and 0.031 w % copper and less than 0.001 w % manganese. This corresponds to a leaching efficiency of 85% cobalt, 83% nickel, 100% copper and less than 1% manganese.
b) 90 g of this leaching filtrate is placed in an autoclave. 0.027 g of a maleic acid olefin copolymer sodium salt (Sokalan CP9®, BASF) is added. The solution is heated up to 200° C. and pressurized with 60 bar hydrogen. The autoclave is kept under these reaction conditions for 2 h. After cooling down, the contents of the autoclave are filtered. The filter residue is washed with deionized water. The filtrate contains 0.023 w % cobalt, 0.061 w % nickel and 0.024 w % copper; comparison with the leaching filtrate obtained in step (a), this corresponds to a recovery of 63% cobalt, 16% nickel and 4% copper as metallic precipitate. This is confirmed by an analysis of the dried filter cake.

### Example 2

A mixture of 34.2 g of ammonium sulfate, 252 g of deionized water, 35 g of ammonium hydroxide solution (28 w %), 93 g of cobalt sulfate solution (9 w %) and 87 g of nickel sulfate solution (10 w %) is used as starting material. 150 g of this solution is placed in an autoclave and heated up to 200° C. and pressurized with 60 bar hydrogen. The autoclave is kept under these reaction conditions for 2 h. After cooling down, the contents of the autoclave are filtered. The filter residue is washed with deionized water. The filtrate (including the washing water) contains 0.16 w % cobalt and 0.0034 w % nickel, which corresponds to a recovery of 65% cobalt and 99% nickel as metallic precipitate.

1-16. (canceled)

17. A process for the recovery of transition metals from batteries comprising:
treating a transition metal material with a leaching agent to yield a leach, wherein the leach comprises dissolved salts of nickel and/or cobalt,
injecting hydrogen gas in the leach at a temperature above about 100° C. and a partial pressure above about 5 bar to obtain a nickel and/or cobalt precipitate in elemental form, and
separating the obtained nickel and/or cobalt precipitate.

18. The process according to claim 17, wherein the hydrogen gas is injected in the leach at a temperature ranging from 150° C. to 280° C.

19. The process according to claim 17, wherein the hydrogen gas is injected in the leach at a partial pressure ranging from 5 bar to 100 bar.

20. The process according to claim 17, wherein the hydrogen gas is injected in the leach at a pH-value above 4.

21. The process according to claim 17, wherein the leaching agent comprises an inorganic acid, an organic acid, a base, or a chelating agent.

22. The process according to claim 17, wherein the transition metal material comprises about 1 wt % to about 30 wt % nickel.

23. The process according to claim 17, wherein, at the treating step, the leach comprises dissolved salts of nickel, and, at the injecting step, elemental nickel is precipitated, optionally in the presence of a nickel-reduction catalyst.

24. The process according to claim 17, wherein
at the treating step, the leach comprises dissolved salts of nickel and cobalt,
at the injecting step, hydrogen gas is injected optionally in the presence of a nickel-reduction catalyst and the obtained nickel and/or cobalt precipitate is a nickel precipitate in elemental form, and
at the separating step, the nickel precipitate is separated to yield a cobalt solution comprising the dissolved salts of cobalt, and further comprising
injecting hydrogen gas in the cobalt solution at a temperature above about 100° C. and a partial pressure above about 5 bar, and optionally in the presence of a cobalt-reduction catalyst, to obtain a cobalt precipitate in elemental form, and
separating the obtained cobalt precipitate.

25. The process according to claim 17, wherein, at the separating step, the obtained nickel and/or cobalt precipitate is separated by magnetic separation.

26. The process according to claim 17, wherein the transition metal material comprises at least one battery component chosen from lithium, lithium compounds, carbon in electrically conductive form, solvents used in electrolytes, aluminum, aluminum compounds, iron, iron compounds, zinc, zinc compounds, silicon, silicon compounds, tin, silicon-tin alloys, organic polymers, fluoride, and compounds of phosphorous.

27. The process according to claim 17, wherein the leach comprises at least one further dissolved component chosen from inorganic salts of iron, manganese, lithium, zinc, tin, zirconium, aluminum, tungsten or copper, and wherein the further dissolved components remain in dissolved form after injecting hydrogen gas in the leach at a temperature above 100° C. and a partial pressure above 5 bar.

28. The process according to claim 17, further comprising removing non-dissolved solids from the leach.

29. The process according to claim 17, further comprising adjusting the pH value of the leach to 2.5 to 8, and removing precipitates of phosphates, oxides, hydroxides, and oxyhydroxides by solid-liquid separation.

30. The process according to claim 17, wherein the transition metal material is obtained from mechanically treated battery scraps, or from smelting battery scrap as a metal alloy.

31. The process according to claim 17, further comprising removing precious metals and/or copper from the leach by cementation.

32. The process according to claim 17, further comprising removing precious metals and/or copper from the leach by depositing the dissolved precious metals and/or copper impurities as elemental precious metal and/or elemental copper on a particulate deposition cathode by electrolysis of an electrolyte containing the leach.
